(19) United States
(12) Patent Application Publication
(10) Pub. No.: US 2004/0087277 A1
(43) Pub. Date: May 6, 2004

(54) Method and apparatus for improving accuracy of radio timing measurements

(75) Inventors: Stephen William Edge, San Diego, CA (US); Bollapragada V.J. Manohar, San Diego, CA (US)

Correspondence Address: Siemens Corporation, Attn: Elsa Keller, Legal Administrator, Intellectual Property Department, 170 Wood Avenue South, Iselin, NJ, 08830, US

(73) Assignee: Siemens Information and Communication Mobile LLC.

(21) Appl. No.: 10/461,007

(22) Filed: Jun. 13, 2003

Related U.S. Application Data
(60) Provisional application No. 60/423,343, filed on Oct. 31, 2002.

(51) Int. Cl. H04B 1/00; H04B 7/00

(52) U.S. Cl. 455/67.16; 455/67.11

(57) ABSTRACT

A system, method, apparatus, means, and computer program code for improving accuracy of radio timing measurements. According to embodiments of the present invention, a terminal may obtain a measurement of each of a plurality of radio transmission sources at a distinct instance in time. In addition, a radio timing measurement for a common radio source is obtained for each of the distinct instants in time. The result will be a pair of radio timing measurements for each distinct instance in time containing smaller adjustment errors than radio timing measurements for all radio sources obtained for one common instant in time. The pairs of radio timing measurements can be used to more accurately support applications in which the geographic position of the terminal is obtained.

### CROSS-REFERENCE TO RELATED APPLICATION

This application is related to, and claims priority to, U.S. provisional patent application Serial No. 60/423,343, entitled METHODS FOR IMPROVING ACCURACY IN RADIO TIMING MEASUREMENTS, and filed Oct. 31, 2002, the entire contents of which are incorporated herein for all purposes.

### BACKGROUND OF THE INVENTION

The present invention relates to a method and apparatus for improving the accuracy of radio timing measurements.

In wireless networks, a wireless handset or, more generally, any wireless terminal device, may need to perform radio timing measurements to support wireless access operation or other applications. Two examples of this occur in technologies to support precise geographic location of the wireless terminal. In GSM (Global System for Mobile Communications), a positioning technology known as E-OTD (Enhanced Observed Time Difference) requires a wireless terminal to measure the transmission timing references carried in the radio transmissions from three or more nearby GSM base stations. The wireless terminal is supposed to measure the exact transmission timing reference from each base station at the same instant in time. The transmission timing reference in GSM is related to the numbering of GSM frames, timeslots and bits transmitted from each base station such that a transmission timing reference for a particular base station would be given by the particular GSM frame number, timeslot number, bit number and fractional portion of a bit that had arrived at the wireless terminal at any specific time. In practice, the wireless terminal would capture a large number of bits from the base station, possibly spanning many GSM frames, and would compute the arrival time at the wireless terminal of a specific marker within this bit sequence, e.g., the start of the first bit in a particular GSM timeslot within some known GSM frame.

In another positioning technology known as A-GPS (Assisted-Global Positioning System), a wireless terminal is required to measure the exact code phase or, if signal reception is good, the exact GPS time indicated by the radio transmission from each one of several GPS satellites (normally at least five, although fewer will sometimes suffice) and at the same instant in time. Each GPS satellite transmits a unique and regularly repeating Gold Code that consists of 1023 chips and is exactly one millisecond in duration. With low signal strength (e.g., as may occur for a wireless terminal positioned indoors), it may only be possible for the wireless terminal to measure the portion of the current Gold Code, the so-called “code phase”, that has arrived at the terminal at the designated measurement time. In that case, the wireless terminal would have determined a fractional millisecond portion of the transmission timing from this GPS satellite but not the full GPS time in terms of a particular day, hour, minute, second and millisecond. With better signal strength, the wireless terminal may be able to decode the GPS satellite transmission data (carried by the recurring Gold Code transmissions) or at least determine sufficient properties of this data to infer the complete GPS satellite time. As with E-OTD, the wireless terminal may have to capture some significant amount of GPS satellite transmission data and compute the arrival time of a particular marker in the transmission (e.g., the precise starting instant of a new Gold Code).

A main problem with both of these positioning technologies and with any other application that requires a wireless terminal to make or measure radio transmission timing from two or more radio transmission sources at the same instant in time is that a wireless terminal may only be able to measure one radio transmission source at a time. In order to obtain radio transmission timing measurements at the same instant in time, a wireless terminal would then need to adjust each transmission timing measurement, made at some other instant in time, to the measurement that would be expected (but cannot actually be made) at the designated common instant in time. While an adjustment might be made by a wireless terminal using an internal clock source (e.g., a crystal oscillator) to determine the amount of time over which the timing measurement must be adjusted, such an internal clock source typically will be imperfect and will introduce some error into the adjustment. The adjustment also could be made using some more precise external clock source, such as GPS time, to determine the interval of adjustment, but this would require significant additional capability in the wireless terminal (in order to receive the external clock source) that would impact cost, size, power requirement etc. Complicating any adjustment is the fact that the wireless terminal may be moving when the measurements are made. In making any measurement at one time in one location and performing an adjustment to a new time, the wireless terminal ought to adjust for the different location at the new time, as well as for the different time, due to propagation delay. However, this may not occur, leading to further errors in the timing adjustment.

It would thus be advantageous to provide methods, means, computer code, and apparatus that overcame the drawbacks of the prior art. In particular, it would be desirable to provide methods, means, computer code, and apparatus that improved accuracy of timing measurements when the measurements are made at different times of two or more external radio transmission sources.

### SUMMARY OF THE INVENTION

Embodiments of the present invention provide a system, methods, apparatus, means, and computer program code for improved accuracy of radio timing measurements when the measurements are made at different times of two or more external radio transmission sources. According to some embodiments of the present invention, a terminal makes a measurement of each of a plurality of sources at instances in time (which may be distinct). In addition, a common source is chosen or otherwise determined and the terminal determines a measurement of the timing of this source for each of the distinct instants. Pairs of radio timing measurements are then created, each pair including an actual measurement taken from one of the sources at a time instant and a radio timing measurement determined from the common source for the same time instant. The terminal then can transmit the pairs of information to another device (e.g., a device in a network) for use in calculating the location of the terminal or for some other application.

In some other embodiments of the present invention, a network or network device receives data associated with a terminal, the data being indicative of radio timing measurements u₁, u₂, . . . , u_{N-1} obtained by the terminal for each of a respective plurality of radio sources 1, 2, . . . , N−1 at respective times T₁, T₂, . . . , T_{N-1} and indicative of radio timing measurements v₁, v₂, . . . , v_{N-1} obtained by the terminal for the common radio source for each of the respective times T₁, T₂, . . . , T_{N-1}. The network or device then determines data indicative of a first real time difference between one of the plurality of radio sources, i say, and the common radio source at the time vᵢ according to the common radio source. Subsequently, the network or device determines data indicative of a first observed time difference at the terminal between said one of the plurality of radio sources and the common radio source at the time vᵢ. The network or device then determines a first geometric time difference for the terminal at time vᵢ based on the first real time difference and the first observed time difference. The network or device then can determine a location for the terminal based, in whole or in part, on the first geometric time difference. In some embodiments, making a radio timing measurement for each of a plurality of radio sources 1, . . . , N−1 at respective times T₁, . . . , T_{N-1} may include making a radio timing measurement for each of a plurality of radio sources 1, . . . , N−1 at respective distinct times T₁₋, . . . , T_{N-1-}; and determining a radio timing measurement for each of said plurality of radio sources 1, . . . , N−1 at distinct times T₁, . . . , T_{N-1} based on the radio timing measurement for each of a plurality of radio sources 1, . . . , N-1 at respective times T₁₋, . . . , T_{N-1-}.

Additional objects, advantages, and novel features of the invention shall be set forth in part in the description that follows, and in part will become apparent to those skilled in the art upon examination of the following or may be learned by the practice of the invention.

According to some embodiments of the present invention, a method for determining timing measurement information may include making a timing measurement for each of a plurality of radio sources 1, . . . , N−1 at respective times Tₗ, . . . , T_{N-1} (some or all of which may be distinct from each other); making a timing measurement of a common radio source N for each of times T₁₊, . . . , T_{N-1+} (some or all of which may be distinct from each other); and determining a timing measurement for the common radio source N for each of the times T₁, . . . , T_{N-1} based on the timing measurement of the common radio source N for each of times T₁₊, . . . , T_{N-I+}. The method may be implemented by a terminal, by an apparatus, device or other means, or by computer code. In some embodiments, the method may include providing data indicative of the timing measurements for the plurality of radio sources 1, . . . , N−1 determined for the respective times T₁, . . . , T_{N-1} and the timing measurements for the common radio source N determined for each of the times T₁, . . . , T_{N-1}. In addition, the method may include determining a real time difference, an observed time difference, and/or a geometric time difference between the common radio source and one or more of the plurality of radio sources. Such information may be used to determine the location of a terminal. In some other embodiments, a method for providing timing measurement information may include making a first measurement of timing information for a first radio transmission source at a first instant in time; making a second measurement of timing information for a common radio transmission source at a second instant in time; determining a third measurement of timing information for the common radio transmission source for the first instant in time based on the second measurement; making a fourth measurement of timing information for a second radio transmission source at a third instant in time; making a fifth measurement of timing information for the common radio transmission source at a fourth instant in time; determining a sixth measurement of timing information for the common radio transmission source for the third instant in time based on the fifth measurement; and providing data indicative of the first measurement, the third measurement, the fourth measurement, and the sixth measurement. In some other embodiments, an apparatus, device, system, computer code, or other means may implement some or all of the elements of one or more of the methods disclosed herein.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system in accordance with the present invention;

FIG. 2 is a diagram of drift and wobble components of a timing source for a terminal;

FIG. 3 is a flowchart of a first embodiment of a method in accordance with the present invention;

FIG. 4 is a flowchart of a second embodiment of a method in accordance with the present invention;

FIG. 5 is a diagram of a relationship between a geometric time difference for any pair of base stations measured by a terminal and the location coordinates of the terminal; and

FIG. 6 is a block diagram of system components for an embodiment of the terminal of FIG. 1.

### DETAILED DESCRIPTION

There is a market opportunity for systems, computer code, means and methods for improving the accuracy of radio timing measurements and for reducing errors when radio timing measurements, made at different times from two or more external radio transmission sources, are adjusted to a common instant in time.

One problem with A-GPS and E-OTD positioning technologies and any other application that requires a wireless terminal to measure radio transmission timing from two or more radio transmission sources at the same instant in time is that a wireless terminal may only be able to measure one radio transmission source at a time. In order to obtain radio transmission timing measurements at the same instant in time, a wireless terminal would then need to adjust each transmission timing measurement, made at some other instant in time, to the measurement that would be expected (but cannot actually be made) at the designated common instant in time. To perform this adjustment, the wireless terminal could make use of some internal clock source plus knowledge of the relationship between this internal clock source and the radio transmission measurement being adjusted. For example, suppose that a GSM wireless terminal is manufactured with an internal frequency source of one gigahertz (GHz) and can thereby associate any event with an internal time source defined in units of one nanosecond. Suppose that the terminal measures the transmission timing from some nearby GSM base station A and detects the arrival of GSM frame 407, timeslot 0 and the start of bit number 0 at an internal time of 20.382709533 seconds. Suppose that the wireless terminal then measures timing from some other base station B and detects the arrival of GSM frame 1254, timeslot 0 and the start of bit 0 at an internal time of 22.527081402 seconds. If the wireless terminal needs to report the transmission timings from both base stations at the same instant in time (e.g., to support E-OTD), it might decide to adjust the transmission timing measurement for base station B to coincide with the measurement for base station A. This would mean calculating the GSM frame, timeslot and bit numbers for B that would have been measured by the wireless terminal at an internal time equal to 22.527081402 minus 20.382709533 which comes to 2.144371869 seconds earlier than the actual measurement of B. Knowing that each GSM frame, timeslot and bit are required by GSM standards to have exact durations of 60/13 (≈4.615) milliseconds (ms), 15/26 ms (≈0.577 ms) and 48/13 (≈3.692) microseconds (μs), respectively, it can be calculated that GSM frame 789, timeslot 3 and bit 13.869 from base station B would have arrived at the earlier measurement time. Mainly for brevity (to send fewer bits), the terminal could then calculate that the start of the next timeslot from base station B would arrive at the wireless terminal after a further time equal to (156.25-13.869) bits, or 142.381 bits, after the measurement from A. For E-OTD, this “Observed Time Difference” (OTD) value between the measurements for base stations A and B would be reported to the network along with the GSM frame, timeslot and bit number values for the base station A.

In the applications described above, a wireless terminal is making measurements of two or more different sources of radio transmission timing at different times and adjusting these measurements to a common time. If the wireless terminal is able to continuously measure some accurate external radio source of timing, then the adjustments can be made using this external time source and errors in the adjustment can be avoided. For example, some implementations of GPS receiver are able to continuously receive GPS signals from one or more satellites. The timing from one of these satellites could then be used to accurately adjust the measurements from all satellites to a common instant in time. Because GPS satellite timing is very precise, such adjustments will be very accurate and enable accurate location estimates. However, when a wireless terminal cannot continuously receive radio transmission timing from some accurate external source, it will need to make use of its own internal clock source, at least in part, to perform any adjustment. In GSM standards, the stability of the transmission timing from any base station or within a GSM terminal is only mandated to be within 0.05 or 0.1 parts per million (ppm), respectively. If the timing measurements of all radio sources were to take ten seconds, for example, that could mean up to one microsecond error in some of the adjustments. A one microsecond error is equivalent to around three hundred meters in distance error if the adjusted measurements were used to calculate location (since radio signals propagate at approximately 300,000,000 meters per second).

The present invention describes new methods to reduce the adjustment errors when radio timing measurements, made at different times, from two or more external radio transmission sources are adjusted to a common instant in time. For purposes of the present invention, it is assumed here that any special techniques to obtain radio timing measurements free of errors due to multipath propagation, interference, noise and other effects that may impair accuracy have already been applied. Thus, the radio timing measurements are considered to be as accurate as can possibly be obtained by the available hardware and software measurement techniques in the wireless terminal except for the need to adjust these measurements to some other instant in time.

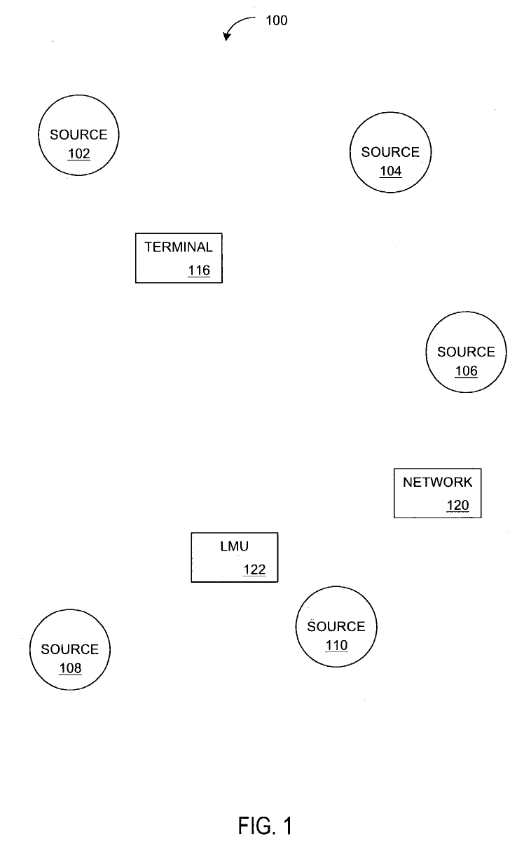

Now referring to FIG. 1, a generic system 100 is illustrated that may be used for discussion of the present invention. The system 100 includes one or more radio transmission sources 102, 104, 106, 108, 110. In some embodiments, a radio transmission source may be or include a base station, GPS or other satellite, wireless LAN server, microwave transmitter, public television or radio transmitter, or other source or broadcaster or transmitter of timing information and different embodiments may use different combinations of radio sources or types of radio sources. In some embodiments, timing information or timing measurement data may be or include GPS Gold Code data or information, GSM timing reference or frame data or information, bit or chip related timing for CDMA or WCDMA or timing data for other wireless technologies including, but not limited to, TDMA, wireless LAN, public radio or television, etc. Each source may include a clock or other time source for making or recording timing measurements, time stamping the transmission or reception of communications, or providing other timing information for use by the source or the system 100.

In addition to sources, the system 100 may include one or more terminals 116 that may detect or otherwise receive signals transmitted or otherwise provided by one or more of the sources 102, 104, 106, 108, 110 for purposes of or including determining the location of the terminal 116 or determining the location of another entity (e.g., one one of the radio sources 102, 104, 106, 108, 110). In some embodiments, the terminal 116 may be or include a mobile and/or wireless device, such as a mobile telephone, handset, PDA, laptop or other communication device. In other embodiments, the terminal 116 may be an entity, or part of an entity, belonging to a wireless network (e.g., a base station or a Location Measurement Unit (LMU)). The terminal 116 may be stationary or mobile. The terminal 116 may include an internal clock or other time source or timing device for making or recording radio timing measurements, time stamping the transmission or reception of communications, or providing other timing information for use by the terminal 116 or the system 100.

In some embodiments, the system 100 also may include a network or other device 120 to which the terminal 116 may communicate. For example, the network 120 may include, or be part of, a GSM, GPRS, TDMA, CDMA or WCDMA wireless network. As used herein, the term “network” also may refer to the network 120 or to a device or group of devices within or forming part of the network 120.

In some embodiments, the network 120 might be or include the Internet, the World Wide Web, or some other public or private computer, cable, telephone, client/server, peer-to-peer, radio or communications network or intranet, as will be described in further detail below. The communications network 120 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. Moreover, as used herein, communications include those enabled by wired or wireless technology. In some embodiments, the network may include, or be in contact with, devices or entities such as Location Measurement Units (LMUs) 122 related to a specific communication architecture, protocol, or implementation (e.g., GSM). In some embodiments implementing or using GSM, a Location Measurement Unit may make radio measurements to support positioning or the location determination of a terminal (e.g., the terminal 116).

To start the discussion and mathematical evaluation of the present invention, some preliminary definitions are given. Define three sets of time references (T₁, T₂, T₃, . . . ), (T*₁, T*₂, T*₃, . . . ), (Tⁿ(T₁), Tⁿ(T₂), Tⁿ(T₃), . . . ) where:

T₁, T₂, T₃, . . . are succeeding instants in time (e.g., T₁<T₂<T₃< . . . ) according to some absolute and correct time source;

T*₁, T*₂, T*₃ . . . are the times recorded at these instants by an internal clock source in the terminal 116; and

Tⁿ(T₁), Tⁿ(T₂), Tⁿ(T₃), . . . are the times actually measured, or that would be measured, at these instants by the terminal 116 from some external radio transmission source n (e.g., the source 110).

It may be supposed for simplification, but not limitation, that the same units of time are employed for all three time sources. If that were not the case initially, one common unit of time, u1 say, could be chosen with any time reference T that was expressed using a different unit, u2 say, converted into it using the product of T with the quotient (u2/u1). Thus, it is assumed here that any such conversion has already been done. Although the three sets of measurements can share a common time unit, they need not share a common time origin whereby identical values for corresponding measurements, Tᵢ, T*ᵢ and Tⁿ(Tᵢ) say, would occur with perfect timing accuracy. Instead, each measurement can be relative to a different time origin because in the results that follow, time origins are not present since only differences between measurements of the same source and errors in measurements appear.

Suppose that the terminal 116 needs to know or report the value of Tⁿ(T₂) but in fact was only able to measure Tⁿ(T₁), then the missing value can be derived by adding in the interval of time between these measurements which, according to a clock in the terminal 116, would be (T*₂−T*₁). This gives:

$$\begin{matrix}{{T}^{n} ( {T}_{2} )}^{\#} = Approximate derived value of {T}^{n} ( {T}_{2} ) & ( 1 ) \\ = {T}^{n} ( {T}_{1} ) + ( {T}_{2}^{*} - {T}_{1}^{*} ) & ( 2 )\end{matrix}$$

The error in the above calculation is obtained as follows:

$$\begin{matrix}E ( {{T}^{n} ( {T}_{2} )}^{\#} / {T}^{n} ( {T}_{1} ) ) = error in deriving {{T}^{n} ( {T}_{2} )}^{\#} using {T}^{n} ( {T}_{1} ) & ( 3 ) \\ = {{T}^{n} ( {T}_{2} )}^{\#} - {T}^{n} ( {T}_{2} ) & ( 4 ) \\ = ( {T}_{2}^{*} - {T}_{1}^{*} ) - ( {T}^{n} ( {T}_{2} ) - {T}^{n} ( {T}_{1} ) ) & \\ \begin{matrix} = [ ( {T}_{2}^{*} - {T}_{1}^{*} ) - ( {T}_{2} - {T}_{1} ) ] - [ ( {T}^{n} ( {T}_{2} ) - {T}^{n} ( {T}_{1} ) ) - \\ ( {T}_{2} - {T}_{1} ) ]\end{matrix} & ( 5 ) \\ = E * ( {T}_{1} , {T}_{2} ) - {E}^{n} ( {T}_{1} , {T}_{2} ) & ( 6 )\end{matrix}$$

where E* (tₘ, tₙ) equals the error in any time interval (tₙ−tₘ) using the clock or other timing device in the terminal 116 and Eⁿ (tₘ, tₙ) equals the error in any time interval (tₙ−tₘ) using the clock or other timing device in the radio source n (e.g., the source 110).

The error in the derivation of the adjusted radio timing for the radio transmission source n is given by the difference in errors of the adjustment interval as measured by the internal clock of the terminal 116 and as would be measured by the timing of the radio source n. The former error occurs because the clock in the terminal 116 was used to perform the adjustment. The latter error occurs because at the required measurement time, T₂, the timing from the radio source n may have “wandered” slightly from what it would have registered with perfect timing accuracy.

In order to precisely evaluate improved methods for reducing errors, some model is needed for the timing errors of the terminal 116 and the external radio transmission source. Such clock sources may exhibit errors containing a constant drift factor and a random wobble. This can be defined mathematically as follows.

Tⁿ(T₎₌RⁿT+T+dⁿT+Xⁿ(T) (7)

T*=R*+T+d*T+X*(T) (8)

where Rⁿ, R* are distinct time origins for T=0; dⁿ, d* equal drift factors for the radio source n and the terminal 116, respectively; and Xⁿ(T), X*(T) equals wobble at time T for the radio source n and the terminal 116, respectively

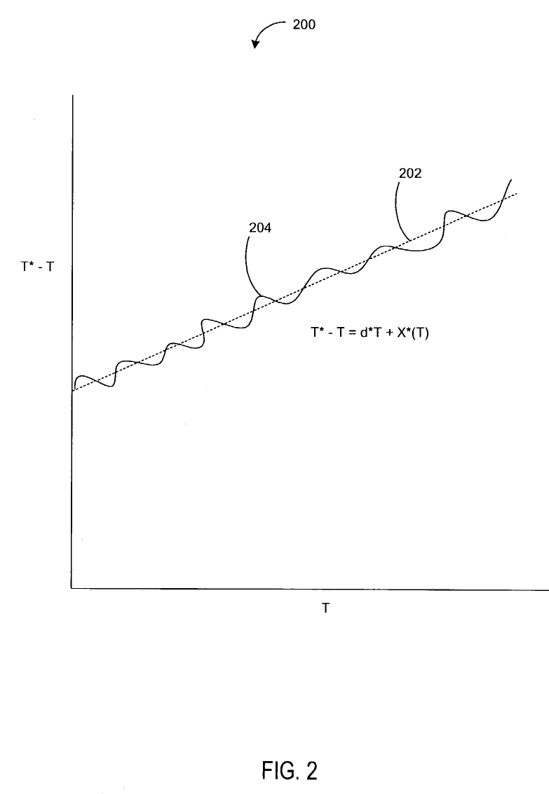

The drift factors would normally be quite small, e.g., GSM mandates a drift factor of less than 0.05 ppm for any base station and less than 0.1 ppm for any mobile terminal. The drift factors are assumed to remain constant, but only over the limited periods considered herein during which radio transmission sources, adjusted to a common instant in time, are being measured. The wobbles Xⁿ(T) and X*(T) represent small fluctuations in timing error, e.g., a sinusoidal component, that will have a high autocorrelation over any small interval of time but can be treated as independent random variables with expectations of zero over any long time period. Intuitively, the drift factor occurs because the frequency source for any clock contains some constant error, i.e., is faster or slower than it should be. Wobble may be the result of random fluctuations, e.g., of temperature or electromagnetic field. Graph 200 in FIG. 2 illustrates the drift component 202 and the wobble component 204 in equation (8).

The errors in the individual clock sources in equation (6) can now be expressed as:

E*(T₁,T₂)=d*(T₂−T₁)+(X*(T₂)−X*(T₁)) (9)

Eⁿ(T₁,T₂)=dⁿ(T₂−T₁)+(Xⁿ(T₂)−Xⁿ(T₁)) (10)

The ensuing error expressed by equation (6) can now be obtained as:

$$\begin{matrix}\begin{matrix}E ( {{T}^{n} ( {T}_{2} )}^{\#} / {T}^{n} ( {T}_{1} ) ) = E * ( {T}_{1} , {T}_{2} ) - {E}^{n} ( {T}_{1} , {T}_{2} ) \\ = [ d * ( {T}_{2} - {T}_{1} ) + ( X * ( {T}_{2} ) - X * ( {T}_{1} ) ) ] - \\ [ {d}^{n} ( {T}_{2} - {T}_{1} ) + ( {X}^{n} ( {T}_{2} ) - {X}^{n} ( {T}_{1} ) ) ] \\ = [ d * ( {T}_{2} - {T}_{1} ) - {d}^{n} ( {T}_{2} - {T}_{1} ) ] + \\ [ ( X * ( {T}_{2} ) - X * ( {T}_{1} ) ) - ( {X}^{n} ( {T}_{2} ) - {X}^{n} ( {T}_{1} ) ) ] \\ = [ ( {d}^{*} - {d}^{n} ) ( {T}_{2} - {T}_{1} ) ] + [ ( X * ( {T}_{2} ) - {X}^{n} ( {T}_{2} ) ) - \\ ( X * ( {T}_{1} ) - {X}^{n} ( {T}_{1} ) ) ]\end{matrix} & ( 11 ) \\ = {E}^{{*}^{n}} ( {T}_{1} , {T}_{2} ) & ( 12 ) \\ where {E}^{{*}^{n}} ( {T}_{1} , {T}_{2} ) = {d}^{{*}^{n}} ( {T}_{2} - {T}_{1} ) + ( {X}^{{*}^{n}} ( {T}_{2} ) - {X}^{{*}^{n}} ( {T}_{1} ) ) & ( 13 ) \\ {d}^{{*}^{n}} = {d}^{*} - {d}^{n} & ( 14 ) \\ {X}^{{*}^{n}} ( T ) = X * ( T ) - {X}^{n} ( T ) & ( 15 )\end{matrix}$$

By comparison of equation (13) with equation (9) or (10), it can be seen that the overall error contains a drift d*ⁿ equal to the difference between the individual drifts for the terminal 116 and radio source n and a wobble X*ⁿ(T) equal to the difference between the individual wobbles. The error due to drift remains proportional to time and will thus increase in proportion to the interval of adjustment. The error due to wobble will have a zero expectation and a variance that is either constant or increases with time (if either of the source n or terminal 116 wobbles had such a variance).

The preceding analysis is applicable to both a moving and a stationary terminal (because no assumption was made regarding the state of motion of the terminal 116). In the case of a moving terminal 116, the transmission timing observed from any radio source will exhibit some additional errors due to Doppler shift. To isolate these, suppose that the timing references for the radio source n, (Tⁿ(T₁), Tⁿ(T₂), Tⁿ(T₃), . . . ), are those that would be observed by the terminal 116 when stationary at the absolute times (T₁, T₂, T₃, . . . ) and at the times according to the terminal 116 of (T*₁, T*₂, T*₃, . .).

Let T^{n,v}(T₁), T^{n,v}(T₂), T^{n,v}(T₃), . . . be the times observed from the same radio source n by the terminal 116 when non-stationary and assume (without loss of generality) that the position of the terminal 116 when non-stationary is the same as the position of the terminal 116 when stationary at time T₁. This implies:

T^{n,v}(T₁)=Tⁿ(T₁)

For simplification, assume that the terminal 116 when non-stationary is moving at some constant velocity. This will not normally be the case, but over a period of just a second or two, this will generally be a good approximation. It is also assumed that the radio transmission source n (e.g., the source 104) is distant from the terminal 116, at least compared with the distance traveled by the terminal 116 over the time period of the adjustments (this simplifies the geometry).

Let vₙ equal the (axial) velocity component of the terminal 116 towards the radio source n. Note that a negative value for vₙ would signify velocity away from the radio transmission source n. The axial velocity component applies to the straight line connecting the terminal 116 to the radio source n at any time. If the radio source n was a GPS satellite then there would be an altitude component to this velocity. If the radio source n is also moving, as in the case of a GPS satellite, then vₙ would denote the axial velocity of the terminal relative to the radio source n. If the timing T^{n,v}(T₂) of the radio transmission source n that would be observed at time T₂ is now derived from a measurement Tⁿ(T₁) made at T₁ in the same way as in equation (2) (i.e., without allowance for the effects due to velocity), the results will be as follows:

$$\begin{matrix}{{T}^{n , v} ( {T}_{2} )}^{\#} = Approximate derived value of {T}^{n , v} ( {T}_{2} ) \\ = {T}^{n} ( {T}_{1} ) + ( {T}_{2}^{*} - {T}_{1}^{*} )\end{matrix} \qquad ( 16 )$$

Because the terminal 116 travels a distance vₙ(T₂−T₁) closer to the radio source n following the measurement Tⁿ(T₁), it would observe a timing reference from n that would not arrive at the terminal 116 if stationary (relative to the radio source n) until a time [vₙ(T₂−T₁)/c] later, where c is the velocity of radio waves (of light). The true measurement that would actually be made at T₂ is thus as follows:

T^{n,v}(T₂)=Tⁿ(T₂+vₙ(T₂−T₁)/c) (17)

If the radio source timing is again modeled as in equation (7), as a combination of drift and wobble, then equation (17) can be expanded as follows:

T^{n,v}(T₂)=Rⁿ+T₂+vₙ(T₂−T₁)/c+dⁿ(T₂+vₙ(T₂−T₁)/c)+Xⁿ(T₂+vₙ(T₂−T₁)/c) (18)

the error in the calculated value for T^{n,v}(T₂)^{#} in equation (16) is then obtained from equation (18) using the drift and wobble equations (9) and (10) as:

$$\begin{matrix}E ( {{T}^{n , v} ( {T}_{2} )}^{\#} / {T}^{n} ( {T}_{1} ) ) = error in deriving {{T}^{n , v} ( {T}_{2} )}^{\#} using {T}^{n} ( {T}_{1} ) & ( 19 ) \\ = {T}^{n , v} ( {T}_{2} ) - {T}^{n , v} ( {T}_{2} ) & \\ = {T}^{n} ( {T}_{1} ) + ( {T}_{2}^{*} - {T}_{1}^{*} ) - {T}^{n , v} ( {T}_{2} ) & \\ = [ {R}^{n} + {T}_{1} + {d}^{n} {T}_{1} + {X}^{n} ( {T}_{1} ) ] + & \\ [ ( {R}^{*} + {T}_{2} + {d}^{*} {T}_{2} + {X}^{*} ( {T}_{2} ) ) - & \\ ( {R}^{*} + {T}_{1} + {d}^{*} {T}_{1} + {X}^{*} ( {T}_{1} ) ) ] - & \\ [ {R}^{n} + {T}_{2} + {v}_{n} ( {T}_{2} - {T}_{1} ) / c + {d}^{n} ( {T}_{2} + {v}_{n} ( {T}_{2} - {T}_{1} ) / c ) + & \\ {X}^{n} ( {T}_{2} + {v}_{n} ( {T}_{2} - {T}_{1} ) / c ) ] & \\ = [ ( {d}^{*} - ( {d}^{n} + {v}_{n} / c ) ) ( {T}_{2} - {T}_{1} ) ] - {d}^{n} ( {v}_{n} / c ) ( {T}_{2} - {T}_{1} ) + & ( 20 ) \\ [ {X}^{n} ( {T}_{1} ) - {X}^{n} ( {T}_{2} + {v}_{n} ( {T}_{2} - {T}_{1} ) / c ) ] + & \\ [ {X}^{*} ( {T}_{2} ) - {X}^{*} ( {T}_{1} ) ] & \\ \approx [ ( {d}^{*} - ( {d}^{n} + {v}_{n} / c ) ) ( {T}_{2} - {T}_{1} ) ] + & ( 21 ) \\ [ {X}^{*} ( {T}_{2} ) - {X}^{n} ( {T}_{2} + {v}_{n} ( {T}_{2} - {T}_{1} ) / c ) ] - & \\ [ {X}^{*} ( {T}_{1} ) - {X}^{n} ( {T}_{1} ) ] & \\ = ( {d}^{*} - {d}^{n , v} ) ( {T}_{2} - {T}_{1} ) + [ ( {X}^{*} ( {T}_{2} ) - {X}^{n , v} ( {T}_{2} ) ) - & ( 22 ) \\ ( {X}^{*} ( {T}_{1} ) - {X}^{n , v} ( {T}_{1} ) ) ] & \\ where {d}^{n , v} = {d}^{n} + {v}_{n} / c & ( 23 ) \\ {X}^{n , v} ( T ) = {X}^{n} ( T + {v}_{n} ( T - {T}_{1} ) / c ) & ( 24 )\end{matrix}$$

In obtaining equation (21) from equation (20), the small second order term involving the product of dⁿ with (vₙ/c) has been ignored. Equation (22) is equivalent to equation (11) for the stationary case with a drift d^{n,v} for the radio source n that is increased by an amount vₙ/c due to (and proportional to) the relative velocity of the terminal 116 and with a wobble X^{n,v} (T) that is the original wobble displaced forward in time by vₙ(T−T₁)/c. A typical maximum speed vₙ for the terminal 116 would be around ninety miles per hour (assuming location restricted to terminals in road vehicles and not in high speed trains or airplanes). This is equivalent to a drift vₙ/c of around 0.134 ppm when the radio source n is fixed as would be the case, for example, with GSM E-OTD. For GSM, this means that the natural drift in a clock at a source can be increased or reduced from the perspective of a moving terminal 116 by almost three times the maximum drift allowed in GSM for the base station.

Equations (22) to (24) show that movement of the terminal 116 (at a constant velocity) can be treated as equivalent to the assignment of a new drift and wobble to the radio source n. Since the methods claimed here for reducing or eliminating the effects of drift and wobble in the timing of the terminal 116 and radio source n do not require knowledge of these, the methods will be equally applicable to moving as well as stationary terminals. Hence in the mathematical evaluations of the various improvements, arbitrary drift and wobbles can be assigned to the radio source n that represent any combination of timing inaccuracy in the radio source n and velocity of the terminal 116.

In the case of a moving radio source n (e.g., a GPS satellite), the same statement applies, except that the drift introduced by a high speed radio source (e.g., GPS satellite) will be much greater and would require compensation by other methods. For example, the velocity of a GPS satellite is about four kilometers per second and, in an axial direction, towards or away from a point on the earth's surface could sometimes attain around one kilometer per second. The associated drift vₙ/c is then around three ppm which, if not removed, will introduce much greater errors into any timing adjustment. The velocity of the GPS satellite can be obtained from data provided by the GPS satellite itself by allowing the timing drift introduced by the motion of the satellite to be obtained, thereby allowing the error introduced by this drift to be obtained and removed from any timing measurement adjustment for the GPS satellite. But in this case, there would be still be a timing drift and associated timing error due to any motion of the wireless terminal which can be reduced by the methods described herein.

Based on the initial mathematical description provided above, methods to reduce and possibly eliminate timing error are now discussed in more detail below.

Process Description

For both the GPS and E-OTD location applications in GSM, the terminal 116 needs to report (or use internally) radio timing measurements for multiple radio sources (e.g., GPS satellites or GSM base stations) taken at the same instant in time. As discussed previously, it may not be possible for the terminal 116 to make all measurements at the same instant in time requiring the terminal 116 to make each measurement at a different instant in time and then adjust each measurement to some common time. As already shown, this can introduce errors that are typically proportional to the time interval over which the measurement has to be adjusted. Therefore, to reduce errors, it would be beneficial to reduce the interval over which each radio timing measurement needs to be adjusted.

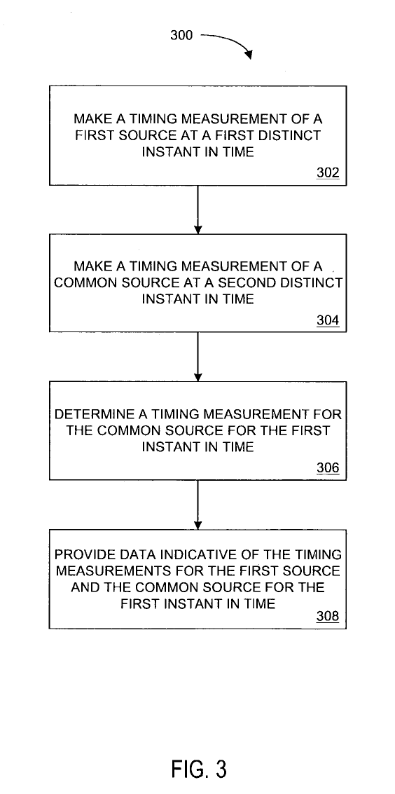

Now referring to FIG. 3, a flowchart 300 is provided that illustrates a first embodiment of the present invention. In general, the method 300 includes the terminal 116 making or taking a measurement of each of a plurality of sources at distinct instances in time. In some embodiments, each of the plurality of sources may be GSM base stations, GPS satellites, etc. In addition, a common source is chosen or otherwise determined and the terminal 116 determines a measurement of the timing of this source for each or associated with each of the distinct instants. In some embodiments, the common source may be different than the remaining sources. Pairs of radio timing measurements are then created, each pair including a radio timing measurement taken or determined from one of the sources at a time instant and a radio timing measurement determined from the common source for the same time instant. The terminal 116 can then transmit the pairs of information to another device (e.g., the network 120) for use in calculating the location of the terminal 116.

More specifically, during a step 302 the terminal 116 makes a measurement of a first source, e.g., the source 102, at a first instant in time (e.g., at time T₁). In some embodiments, making a radio timing measurement of a source may include receiving and filtering radio frequency (RF) signals from the source, converting these to baseband frequency (the frequency at which signaling data is encoded), demodulating the baseband signal to yield data signal bits, searching for a particular fixed or expected sequence of bits and determining the time according to the terminal's internal clock source when a particular bit within the fixed sequence (e.g., the start of the first bit) was received by the terminal. In other embodiments, the RF signal from the source might be correlated against a particular expected RF signal sequence or pattern to determine where in the RF signal the latter may occur, with the time of reception of some known marker within the RF sequence or pattern then being determined according to the internal clock source of the wireless terminal. In yet other embodiments, the RF signal might be converted to a lower intermediate frequency before being sampled and measured. In further embodiments, the sequence of bits received from the radio source by the wireless terminal might be decoded and interpreted to obtain an explicit timing reference (e.g., frame number and timeslot number in GSM or date and time for GPS) or the explicit timing reference might be obtained from an RF signal other than the one being measured and from the same or a different radio source (e.g., GPS date and time from a different GPS satellite or GSM frame number from a different RF channel from the same GSM base station). Other techniques for measurement also are possible and are not precluded by this invention.

During a step 304, the terminal makes a radio timing measurement from a common source, e.g., the source 110, at a second instant in time (e.g., a time T₁₊). The step 304 may occur prior to or after the step 302. That is, the first instant of time may occur before or after the second instant of time. During a step 306, the terminal determines the radio timing measurement for the common source 110, for the first instant in time. To perform this radio timing measurement adjustment, the terminal 116 can make use of its internal clock or other timing source plus knowledge of the relationship between this internal clock or other timing source and the radio transmission measurement being adjusted, as previously described above. During a step 308, the terminal 116 can provide information regarding the measurements obtained from, or determined for, the source 102 and the common source 110. For example, the terminal 116 might transmit or otherwise provide the measurement information to a Serving Mobile Location Center (SMLC) for GSM or to a Position Determining Entity (PDE) for TDMA or CDMA. The step 308 may not be used or conducted in all embodiments of the method 300.

In some embodiments, measurement information might be provided for other sources in addition to the source 102, where a radio timing measurement from the common source 110 is taken for each radio timing measurement from the other sources. Some or all of the radio sources may begat distinct locations. For example, let the radio sources be numbered 1, 2, 3, . . . , N and suppose source N (e.g., the source 110) is chosen as the common source. Then a radio timing measurement of each source 1, 2, 3, . . . , N−1 is made at times T₁, T₂, T₃, . . . , T_{N-1}. A radio timing measurement of the source N is then also obtained for each time T₁, T₂, T₃, . . . , T_{N-1}. Since the radio source N may not be measurable at precisely these instants (because at each instant, one of the other sources is being measured), radio timing measurements of it close (e.g., less than one second) to these instants (e.g., at times designated as T₁₊, . . . , T_{N-1+}) would be made and then adjusted to correspond to the required instants. The time T₁₊ may occur before or after the time T₁, the time T₂₊ may occur before or after the time T₂, etc.

The series of times, T₁, T₂, T₃, . . . , T_{N-1}, can be close together (e.g., less than ten seconds between each successive time) to reduce errors in any subsequent usage of them (e.g., to compute the location of the terminal 116). The result of all this will be N−1 pairs of timing measurements (u₁, v₁), (u₂, v₂), (u₃, v₃), . . . , (u_{N-1}, v_{N-1}), where uᵢ is the radio timing measurement made for radio source i at time Tᵢ and vᵢ is the measurement for the common source N obtained (but not necessarily measured) for time Tᵢ. The calculated measurements, v₁, v₂, v₃, . . . , v_{N-1}, for the radio source N can be more accurate (contain smaller errors) than the calculated measurements would be for all radio sources if these all had to be adjusted to one common instant in time, because by making measurements for the source N close to each of the N−1 time instants, smaller adjustment intervals are possible. This was demonstrated earlier here through equations (1) to (15) where it was shown that if the common radio source N and clock source for the terminal 116 were to each contain a constant drift factor, then the error in adjusting any measurement for the radio source N would be proportional to the interval of time for which the adjustment was made. Even if the clock sources for the terminal 116 and common radio source N were extremely accurate and stable, any significant motion of the terminal 116 during the period in which measurements were made would lead to an adjustment error equivalent to clock drift, as demonstrated here earlier through equations (16) to (24). The error introduced by such motion would again be proportional to the period over which any measurement was adjusted and would thus be reduced by making the adjustment intervals as small as possible as enabled by the invention described herein.

The actual measurements, u₁, u₂, u₃, . . . , u_{N-1}, for the other radio sources will contain no errors due to adjustment (because no adjustment is needed). Therefore, the resulting pairs of measurements are more accurate, although they are no longer at a single common instant in time. A device receiving the pairs of measurements can use the data to make a determination of the location of the terminal. In general terms, this is possible because the correspondence of any pair of measurements, for example uᵢ for radio source i and vᵢ for the common source N at the time Tᵢ, imposes some restriction on the location of the terminal 116 at the time Tᵢ. If the same measurements had been made at this time from some other location closer to or further away from either radio source, different results would have been obtained due to finite radio propagation delays. In particular, the difference between the pair of measurements, uᵢ−vᵢ, would change unless the difference between the distances to each radio source remained the same. This latter property enables a location estimate to be obtained from pairs of measurements for a plurality of radio sources as shown later here for some specific position methods for GSM.

It should be noted that while the preceding discussion has assumed that measurements for the common radio source N were adjusted to correspond to the times at which measurements for the other radio sources, 1, 2, . . . N−1, were obtained, the reverse could also occur. In that case, the times T₁, T₂, T₃, . . . , T_{N-1} would be the actual times at which the measurements v₁, v₂, v₃, . . . , v_{N-1} for the radio source N were made and the measurements u₁, u₂, u₃, . . . , u_{N-1} for the other radio sources would be obtained by adjusting measurements for these radio sources obtained at slightly different times (e.g., at times T₁₋, . . . , T_{N-1-}). Provided any measurement for a radio source, i say, is made close to the time Tᵢ, the error in the adjusted measurement uᵢ will be small. More generally still, in each measurement pair, (uᵢ, vᵢ), either measurement might be made at the time Tᵢ with the other measurement obtained by adjustment over a short time interval. In addition, it would be possible to obtain both measurements, uᵢ and vᵢ, in any measurement pair, from measurements made at a slightly different time to the time Tᵢ for which the measurements are obtained. For example, if the radio source i was measured at a time T and the common radio source at a time T+δT close to T, the terminal might adjust both measurements to an intermediate time Tᵢ equal to T+δT/2, which would tend to minimize the worst case adjustment error. Furthermore, the wireless terminal might measure some or all radio sources more than once and obtain any measurement, uᵢ, or vᵢ, from more than one measurement. For example, the wireless terminal might measure the timing of the radio source i at a time Tᵢ−δT and then again at a time Tᵢ+δT. Both measurements might then be separately adjusted to the time Tᵢ, using the terminal's internal clock source, and then averaged to provide the final adjusted time measurement uᵢ. Fewer measurements of the common radio source N might also be obtained than the number of other radio sources N−1. For example, if the other radio sources were measured at precisely the times, T₁, T₂, T₃, . . . , T_{N-1}, the common radio source N might be measured at intermediate times (T₁+T₂)/2, (T₃+T₄)/2, (T₅+T₆)/2, etc. with any measurement made at time (Tᵢ+Tᵢ₊₁)/2 being adjusted to give two measurements, vᵢ and vᵢ₊₁, corresponding to the times Tᵢ and Tᵢ₊₁. This variation halves the number of measurements of the common source N and thus reduces the overall measurement time. None of these extensions and generalizations are precluded by the invention herein.

In some embodiments, making a timing measurement for each of a plurality of radio sources 1, . . . , N−1 at respective times T₁, . . . , T_{N-1} may includes making a timing measurement for each of a plurality of radio sources 1, . . . , N−1 at respective times T₁₋, . . . , T_{N-1-}; and determining a timing measurement for each of the plurality of radio sources 1, . . . , N−1 at times T₁, . . . , T_{N-1} based on the timing measurement for each of a plurality of radio sources 1, . . . , N−1 at respective times T₁₋, . . . , T_{N-1-}. The time T₁₋ may occur before or after the time T₁, the time T₂₋ may occur before or after the time T₂, etc. In addition, in some embodiments, some or all of the times T₁₊, . . . , T_{N-1+} may be the same as each other or may be distinct from each other.

As illustrated in the discussion above, in some embodiments a method for providing radio timing measurement information may include making a first measurement of radio timing information for a first radio transmission source at a first instant in time; making a second measurement of radio timing information for a common radio transmission source at a second instant in time; determining a third measurement of radio timing information for the common radio transmission source for the first instant in time based on the second measurement; making a fourth measurement of radio timing information for a second radio transmission source at a third instant in time; making a fifth measurement of radio timing information for the common radio transmission source at a fourth instant in time; determining a sixth measurement of radio timing information for the common radio transmission source for the third instant in time based on the fifth measurement; and providing data indicative of the first radio timing measurement, the third radio timing measurement, the fourth radio timing measurement, and the sixth radio timing measurement. Similarly, in some embodiments, a method for providing radio timing measurement information may include making a first measurement of radio timing information for a first radio transmission source at a first instant in time; determining a second measurement of radio timing information for the first radio transmission source at a second instant in time based on the first measurement; making a third measurement of radio timing information for a common radio transmission source at a third instant in time; determining a fourth measurement of radio timing information for the common radio transmission source for the second instant in time based on the third measurement; making a fifth measurement of radio timing information for a second radio transmission source at a fourth instant in time; determining a sixth measurement of radio timing information for the second radio transmission source at a fifth instant in time based on the fifth measurement; making a seventh measurement of radio timing information for the common radio transmission source at a sixth instant in time; determining an eighth measurement of radio timing information for the common radio transmission source for the fifth instant in time based on the seventh measurement; and providing data indicative of the second measurement, the fourth measurement, the sixth measurement, and the eighth measurement.

In the GPS and E-OTD applications discussed above, radio timing measurements for multiple radio sources are needed for a single common instant in time. To obtain measurements at a common instant in time from N−1 pairs of measurements made at N−1 different times, the network 120 could make use of information that is not known to the terminal 116 to make the adjustments more accurately. For example, if the network 120 knows the exact relationship between the (generally inaccurate) timing of each radio source n and true absolute time (e.g., the network 120 knows the drift and wobble in equation (7)), then the network 120 can accurately adjust each pair of radio timing measurements to a common instant in time in the case that the radio sources and the wireless terminal are all stationary. If the network 120 only knows the general relationship between the timing of each radio source n and true absolute time (e.g., the network 120 knows the drift in equation (7) but not the wobble), then the network 120 can still derive timing measurements for a common instant in time with smaller error (in this case just the wobble) than if the adjustment was performed by the terminal 116. The network 120 can know these relationships through the deployment of additional devices that continuously monitor and report on the timings of external radio transmission sources. For example, with GSM, Location Measurement Units (LMUs) have been defined to monitor and report on base station (i.e., source) radio timing either relative to the timing of other base stations (i.e., other sources) or relative to an absolute time source like GPS. Lastly, if the terminal 116 may be moving and thus adding an additional unknown drift factor to the radio timings of each radio source n, the network 120 can use additional pairs of radio measurements to calculate this drift (i.e., the velocity of the terminal 120) as well as other data that is required from the measurements.

As a specific example and demonstration of these improvements, consider the case where the application is GSM E-OTD. For E-OTD, a GSM terminal (e.g., the terminal 116) is required to report radio timing measurements for a reference base station (e.g., the source 102) and two or more other nearby base stations (e.g., the sources 104, 106, etc.) at the same instant in time. Knowledge of base station timings at the same instant in time is normally needed to compute the location of the terminal 116 according to the standard method of operation for E-OTD. In accordance with the present invention, radio timing measurements for base stations (e.g., the sources 102, 104, 106, etc.) would be reported instead in pairs (u₁, v₁), (u₂, v₂), (u₃, v₃), . . . , (u_{N-1}, v_{N-1}), where uᵢ is the radio timing measurement made for each nearby base station i at time Tᵢ and vᵢ is the measurement for the common reference base station N (e.g., the source 110) obtained (but not necessarily measured) for time Tᵢ. As indicated earlier, only one of each pair of measurements (uᵢ or vᵢ) need be reported completely (as a GSM frame number, timeslot number, bit number and possibly fraction of a bit). The other measurement can be reported relative to this (modulo the GSM timeslot duration) as a so called “Observed Time Difference” (OTD) that comprises just a fractional portion (expressed in bits and fractions of a bit) of a GSM timeslot. Expressing an OTD relative to one timeslot without including the number of whole timeslots and frames in the timing difference means that the measurement reported using the OTD cannot be fully recovered: only the fractional timeslot portion of the measurement would be recovered. This is not important to E-OTD since the OTD values are used directly to determine location, while the time measurement in each pair that is fully reported would be sufficient to indicate the time when both measurements were obtained. Note that the absolute measurement times, Tᵢ, are not and cannot be reported, just the radio timings.

In order to use these measurements to calculate a location according to E-OTD, one of two approaches can be taken. The terminal 116 could be considered to be stationary with the measurements then adjusted to a common instant in time making use of additional knowledge of the timings of base stations, e.g., from LMUs. Note that even if the terminal 116 is moving, the stationary assumption can still be valid if the velocity of the terminal 116 is low or the time interval between the first and last pairs of measurements is small, since the distance traveled by the terminal 116 will then be small. For example, if all pairs of measurements are made within a three second interval and the terminal 116 is traveling at thirty miles per hour, then the terminal travels 132 feet which may be an acceptable error in a location estimate.

When allowance is made for movement of the terminal 116, each pair of measurements (uᵢ, vᵢ) can be combined with the Real Time Difference, RTDᵢ, between each base station i (e.g., each source 102, 104, etc.) and the reference base station N (e.g., the source 110) at either the time uᵢ according to the base station i or the time vᵢ according to the reference base station (depending on whether uᵢ or vᵢ or both are completely available) to yield an equation relating the horizontal x and y coordinates of the terminal 116 at this time. Note that RTDs can be measured in GSM by LMUs and provided to some central entity or device in the network 120. The following illustrates how this can be done when timing measurements and coordinates are referenced to the timing from the reference base station.

| Let RTDᵢ (vᵢ) = | Real Time Difference between base station i (e.g., the | |
|---|---|---|
| | source 102) and reference base station N (e.g., the source | |
| | 110) at time vᵢ according to the reference base station. | |
| | Real time difference is the amount of time between the | |
| | start of transmission of a new GSM timeslot from the | |
| | reference base station and the start of the transmission of | |
| | the next timeslot from the neighbor base station as would | |
| | be observed if an absolute time source was measuring | |
| | this next to each base station. The real time differences | |
| | would normally be measured by GSM LMUs and | |
| | provided to the network (e.g., to a central network entity | |
| | such as a GSM SMLC). Other methods of obtaining real | |
| | time differences without the use of LMUs are not | |
| | precluded, however. If the real time difference RTDᵢ had | |
| | not been obtained at exactly the time vᵢ but at some other | |
| | time, the real time difference at vᵢ could be obtained from | |
| | its functional relationship to the reference base station | |
| | time. For example, if RTDᵢ was increasing or decreasing | |
| | at a constant rate, the RTDᵢ at vᵢ could be obtained by | |
| | simple interpolation or extrapolation of RTDᵢ values | |
| | obtained close to vᵢ. | |
| Let OTDᵢ (vᵢ) = | Observed Time Difference at the terminal 116 between | |
| | base station i and reference base station N at the | |
| | reference base station time vᵢ. Observed time difference | |
| | is the apparent RTD observed by the terminal 116. | |
| | OTDᵢ (vᵢ) would either be reported by the terminal 116 or | |
| | derived from the full measurements, uᵢ and vᵢ, if these | |
| | were reported. Thus, the OTD values would be obtained | |
| | from the measurements provided by the terminal 116. | |
| Let GTDᵢ (vᵢ) = | Geometric Time Difference between base station i and | |
| | reference base station N at the reference base station time | |
| | vᵢ. | |
| = | OTDᵢ (vᵢ) − RTDᵢ (vᵢ) | (25) |

| | |
|---|---|
| Let (xᵢ, yᵢ) = | horizontal coordinates of base station i (e.g., the source |
| | 102). |
| (x_{N}, y_{N}) = | horizontal coordinates of reference base station N (e.g., |
| | the source 110). |

Then, ignoring differences in altitude coordinates, which are normally not significant, the following equation well known to those versed in the art will apply.

GTDᵢ(vᵢ)=[[(y(vᵢ)−yᵢ)²+(x(vᵢ)−xᵢ)²]^{1/2}−[(y(vᵢ)−y_{N})²+(x(vᵢ)−x_{N})²]^{1/2}]/c (26)

Equation (26) relates the (unknown) horizontal coordinates, x(vᵢ) and y(vᵢ), of the terminal 116 at time vᵢ to the (known) coordinates of the reference and neighbor base stations and the (known) measurement of timings made by the terminal 116 (OTD) and by some monitoring device like an LMU (RTD). The relationship is that the terminal 116 coordinates lie along a certain hyperbola defined by the other known values in this equation. If the terminal 116 was not moving, measurements for two such equations would generally suffice to obtain both coordinates uniquely as the point of intersection of the two hyperbolae, although more equations resulting from measurements on more than just two neighbor base stations would usually improve accuracy. If movement of the terminal 116 is allowed and is assumed to be in a straight line at a constant velocity, then two more (unknown) variables must be obtained as follows.

Let

(X, Y)=velocity of the terminal 116 in the x and y coordinate directions

Then

y(vᵢ)=y(vⱼ)+Y(vᵢ−vⱼ) (27)

x(vᵢ)=x(vⱼ)+X(vᵢ−vⱼ) (28)

Equations (27) and (28) relate the x, y coordinates of the terminal 116 at different times vᵢ and vⱼ (i≠j) according to the reference base station timing, where it assumed that the differences in these timings will be very close to corresponding absolute differences in times. Solutions for the coordinates, x(t) and y(t), of the terminal 116 at any time t and the values of the velocity components, X and Y, (four variables altogether) can be obtained as the solutions to four pairs of measurements in equations (26), (27) and (28). Additional measurements would serve to improve the accuracy of these solutions. Where the present invention has improved the solution for E-OTD is in enabling the effects of velocity to be obtained when the terminal 116 is moving. Without this improvement, velocity of the terminal 116 would introduce errors into the adjusted measurements when the adjustment is made by the terminal 116 to a single common instant of time for all measurements. When the terminal 116 is not moving, the measurements provided by the terminal 116 according to the present invention can be adjusted more accurately by the network 120, as opposed to by the terminal 116, to a common instant in time, thereby also producing a more accurate location estimate. However, in some embodiments, the terminal 116 may determine the real time differences, observed time differences, and/or geometric time differences discussed above and use them to determine its location. In addition, the terminal 116 may send or otherwise provide data indicative of the real time differences, observed time differences, and/or geometric time differences as well as its location.

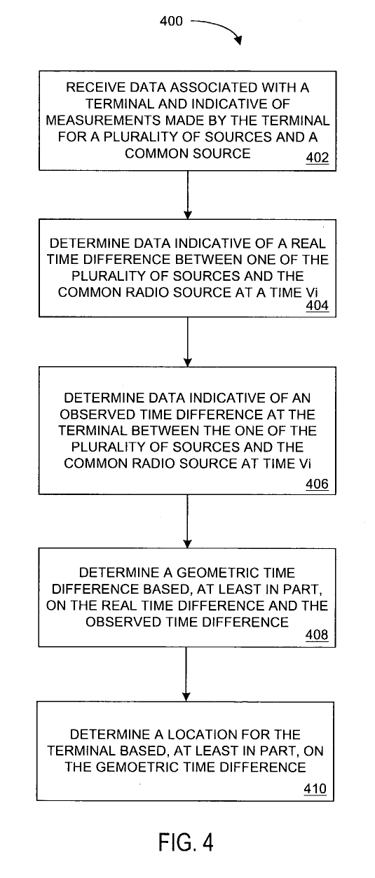

Reference is now made to FIG. 4, where a flow chart 400 is shown which represents the operation of a second embodiment of the present invention as described above. The particular arrangement of elements in the flow chart 400 is not meant to imply a fixed order to the steps; embodiments of the present invention can be practiced in any order that is practicable. In some embodiments, some or all of the steps of the method 400 may be performed or completed by the network 120 and/or one or more devices in the network 120.

Processing begins at a step 402 during which the network 120 receives data associated with a terminal (e.g., the terminal 116), the data being indicative of measurements, u₁, u₂, u₃, . . . , u_{N-1}, made by the terminal for each of a plurality of radio sources 1, 2, . . . , N−1 at respective distinct times T₁, T₂, . . . , T_{N-1} and indicative of measurements, v₁, v₂, v₃, . . . , v_{N-1}, made by the terminal for the common radio source for each of the times T₁, T₂, . . . , T_{N-1}.

During a step 404, the network determines data indicative of a first real time difference between one of the plurality of radio sources and the common radio source at a time vᵢ according to the common radio source. More specifically, one or more Location Measurement Units (LMUs), deployed at fixed known locations in the network, could measure the transmission timing arrival from one or more of the plurality of radio sources. Each LMU could obtain timing measurements for pairs of radio sources at the same instant in time for each pair. To enable this, the LMU could make a measurement of some known signal (e.g., start of a specific GSM timeslot) from one radio source at a certain time T and determine a second measurement for another radio source at the same time T by performing a measurement at a slightly different time, T+δT or T−δT, and then adjusting this to the required time T using the LMU's internal clock (which can be much more accurate and stable than that in a typical wireless terminal). The difference in timing measurements between the two sources would represent the observed time difference at the LMU location and could be easily converted (e.g., using equations similar to (25) and (26)) into the real time difference using the known distances and thus known propagation times from the LMU to either radio source. Real time differences at times other than those at which the LMU performed measurements could be obtained by interpolation or extrapolation, e.g., by determining some constant drift in the real time difference over time and including this drift in the interpolation or extrapolation procedure. An LMU could also perform a timing measurement of each radio source in isolation and associate this with a timing measurement of some universal time source like time from a GPS satellite. Such absolute timing measurements, performed for two distinct radio sources, could be used to obtain real time differences by determining the time measurement from each radio source that would occur at the same universal time. The difference between these two time measurements would be the real time difference between the two radio sources at that particular universal time. Other methods of determining real time difference are also possible including but not limited to measuring absolute time correspondence in the base stations themselves (e.g., using a GPS receiver in each base station) and synchronizing the timing of each base station to a common universal time (e.g., GPS time) such that real time differences between pairs of base stations will all be zero.

During a step 406, the network 120 determines data indicative of a first observed time difference at the terminal between said one of the plurality of radio sources, i say, and the common radio source at the time vᵢ. More specifically, the network obtains the difference between the pair of measurements, uᵢ and vᵢ, reported by the terminal for the radio source i and the common radio source. This difference is the observed time difference at the time vᵢ according to the common radio source.

During a step 408, the network 120 determines a first geometric time difference for the terminal at time vᵢ based on the first real time difference and the first observed time difference. For example, the network 120 may use the formulation discussed above in relation to equations (25) and (26).

During a step 410, the network 120 determines a location for the terminal based, in whole or in part, on the first geometric time difference determined during the step 408. As previously described above, in some embodiments the location of the terminal may lie along a hyperbola defined by the equation (26). Other information may be needed to pinpoint the location of the terminal along the hyperbola and the network 120 may determine such information as part of the method 400. Similarly, if the terminal is moving, the network 120 also may determine additional information as part of the method 400, as previously described above.

The location obtained in the step 410 will normally be more accurate (have a smaller error) than one obtained without the present invention for the following reasons. First, the provision by the terminal in the step 402 of pairs of timing measurements for the plurality of radio sources and the common radio source at distinct times reduces possible errors in these measurements. With the present invention, the terminal provides a pair of measurements for each radio source, one obtained for that radio source and one obtained for the common radio source. These two measurements are obtained for the same instant in time (e.g., T). Normally, one of the two measurements can have been made at exactly this instant and thus need not contain any error due to adjustment. The other measurement can have been made at a time (e.g., T#), very close to T and will be adjusted by the terminal to correspond to the required common time T. Normally this adjustment will make use of the terminal's own internal clock source which will typically contain drift and wobble components. As shown previously in the discussion associated with equations (1) to (15) above, the error in the adjustment will then be proportional to the time over which the adjustment is made, i.e., proportional to the difference between the required time T and the measurement time T#. So the closer T# is to T, the more accurate will be the reported pair of measurements. Without using the present invention, the terminal would typically determine measurements for all radio sources at the same instant in time because many applications of timing measurements, such as GSM E-OTD or GPS positioning, require this. Because each radio source normally should be measured at a different time, the measurements would have to be adjusted to the common instant. Some measurements will inevitably be made at longer intervals of time from this common instant than others. The adjustment errors for these will then tend to be greater, e.g., will be proportional to the interval of adjustment according to equations (1) to (15) if the terminal's internal clock source contains drift and wobble components. In particular, the adjustment errors will be greater than those with the present invention because the intervals over which the measurements are adjusted with normally be greater. Although the present invention may require that the network subsequently adjust the received pairs of measurements (made at a different time for each pair) to a single common time, the adjustment can be more accurate than if made in the wireless terminal because the network can use additional information (e.g., provided by LMUs) on the relationship of radio source timing, e.g., real time differences or absolute time differences, that is not available to the terminal and enables more accurate timing adjustment. Any location thus obtained from the measurements provided by the present invention would then be more accurate than a location obtained from measurements without using the invention.

In the case that the terminal has a significant velocity, the present invention allows the effect of the velocity to be taken into account when determining a location as shown by the discussion associated with equations (25) to (28). Without using the present invention, with all measurements adjusted by the terminal to the same instant in time, the velocity of the terminal will introduce an additional timing drift for each radio source proportional to the velocity as shown by the discussion associated with equations (16) to (24). This will introduce additional errors into the adjusted measurements that will lead to further error in any location estimate derived from these measurements. Furthermore, the velocity of the terminal could not be obtained then.

In the case of GSM, the clock drift for any base station can be as high as 0.05 ppm while the clock drift for a wireless terminal can be up to 0.1 ppm. Depending on the relative directions of clock drift (e.g., see equation (14)), the error component in a timing reference could be as high as the sum of both drifts multiplied by the interval of time over which the timing reference is adjusted. For example, with a measurement adjusted forwards or backwards in time over five seconds and with the worst case drift sum of 0.15 ppm, the error would be 0.75 μs. In more typical cases where the actual drifts are less than the maximums permitted by GSM standards, errors of some significance may still arise.

With the methods described herein, it is possible to reduce the time interval over which timing references need to be adjusted by obtaining timing references for radio sources in pairs with one reference radio source being common to all pairs. In the case of E-OTD, the reference radio source would be the reference base station while the other radio sources would be other nearby base stations. For example, if an adjustment interval can be reduced from five seconds to one second for each pair of time references, the maximum error due to drift would be reduced from 0.75 μs down to 0.15 μs.

The effect on the resulting location estimate of reducing errors in the OTD measurements for E-OTD is now determined. From equation (26), there is a relationship between the GTD for any pair of base stations measured by a wireless terminal and the location coordinates of the wireless terminal. This relationship can be expressed in the form:

M=f(x,y) (29)

where

M=[GTDᵢ(vᵢ)c] from equation (26)

x, y=x(vᵢ), y(vᵢ), respectively, in equation (26)

f(x, y)=[[(y−yᵢ)²+(x−xᵢ)²]^{1/2}−[(y−y_{N})²+(x−x_{N})²]^{1/2}]

The x and y coordinates of the wireless terminal would be obtained in part from M using equation (29). If there was some error in M, there would be some error in x and y. Since M (or GTDᵢ (vᵢ)c) is the difference between a measured OTD value and an RTD from equation (26) multiplied by the velocity of light c, any reduction of error in the OTD value, after multiplication by c, will imply an equal reduction of error in M. To determine the effects of an error in M on x and y, proceed as follows.

Taking partial derivatives gives:

$$\begin{matrix}dM = {f}_{x} dx + {f}_{y} dy & ( 30 ) \\ where {f}_{x} = \partial f ( x , y ) / \partial x & ( 31 ) \\ {f}_{y} = \partial f ( x , y ) / \partial y & ( 32 ) \\ Let ds = {( {dx}^{2} + {dy}^{2} )}^{1 / 2} & ( 33 ) \\ α = {tan}^{- 1} ( ⅆ y / ⅆ x ) & ( 34 ) \\ = {sin}^{- 1} ( ⅆ y / ⅆ s ) & ( 35 ) \\ = {cos}^{- 1} ( ⅆ x / ⅆ s ) & ( 36 )\end{matrix}$$

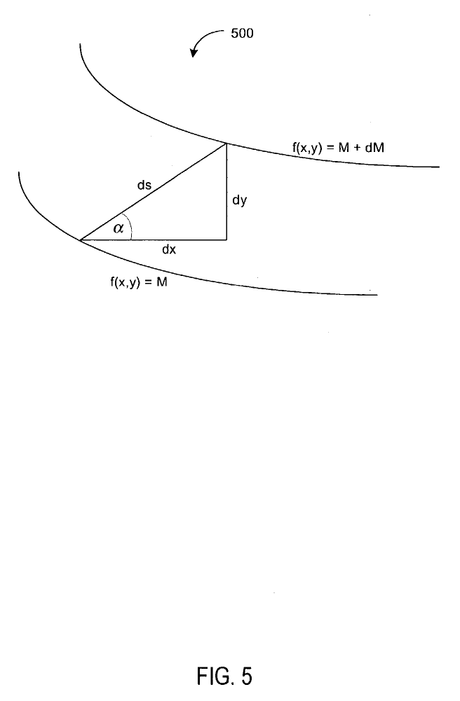

In equation (30), dM is the change in M associated with a change dx and dy in the calculated coordinates of the wireless terminal. In equation (33), ds is the total length in the change in the calculated position of the wireless terminal. In equations (34), (35) and (36), angle α is the angle subtended between dx and ds, as illustrated in graph 500 in FIG. 5.

From equations (30), (35) and (36):

$$\begin{matrix}ⅆ M / ⅆ s = {f}_{x} cos ( α ) + {f}_{y} sin ( α ) & ( 37 ) \\ ⅆ ( ⅆ M / ⅆ s ) / ⅆ α = - {f}_{x} sin ( α ) + {f}_{y} cos ( α ) & ( 38 ) \\ = 0 when tan ( α ) = {f}_{y} / {f}_{x} & ( 39 )\end{matrix}$$

The values of the angle α for which dM/ds in equation (27) attains its maximum positive and negative values is obtained when the derivative of dM/ds with respect to a in equation (38) is zero. This is the value of a given in equation (39). This value of a will thus minimize |ds/dM|—i.e. it will minimize the amount ds by which the calculated location of the wireless terminal as computed using equation (29) changes due to some change in M, for example, an error in the measured value of M. This quantity (minimum |ds/dM|) is well known in the art as “the geometric dilution of precision” (GDOP) for any equation relating a location measurement (e.g., GTD) to the coordinates of the entity being measured. From the preceding, it is given by:

$$\begin{matrix}GDOP = minimum value of \vert ⅆ s / ⅆ M \vert \\ = \vert 1 / ( {f}_{x} cos ( α ) + {f}_{y} sin ( α ) ) \vert with tan ( α ) = {f}_{y} / {f}_{x} \\ = \vert {( {f}_{x}^{2} + {f}_{y}^{2} )}^{- 1 / 2} \vert\end{matrix} \qquad ( 40 )$$

Equations (29) and (40) enable values for the GDOP to be obtained for different geometrical relationships of the wireless terminal, reference and neighbor base stations. Investigation of GDOP values has already occurred for E-OTD (and other position methods) and, as is well known in the art, typical values range from around 0.5 up to around 5.0. The significance of any GDOP value is that it implies the error in a location estimate due to an error in some measurement. In the case of E-OTD, an error in an OTD factor due to uncompensated clock drift (after multiplication by the velocity of light c) will thus result in a location error of generally between 0.5 and 5.0 times the OTD error. From the previous examples, worst case OTD errors of up to 0.75 μs were shown. This corresponds to a distance of approximately 225 meters when multiplied by c. The corresponding location error would then be 112.5 to 1125 meters for a GDOP range of 0.5 to 5. For a more realistic OTD error of say 0.075 μs due to drift factors one tenth of the maximum allowed by GSM standards, the location error range solely due to uncompensated drift would still be 11.2 to 112.5 meters in this example. Although these are only examples, they illustrate the kind of location error contributions for E-OTD that could be mostly eliminated by the application of the methods described herein.

Terminal

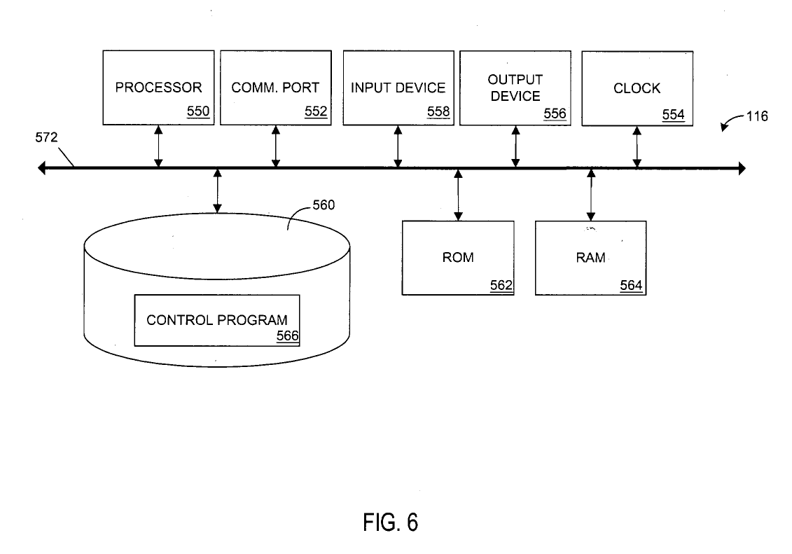

Now referring to FIG. 6, a representative block diagram of a terminal 116 is illustrated. The terminal 116 may include a processor, microchip, central processing unit, or computer 550 that is in communication with or otherwise uses or includes one or more communication ports 552 for communicating with devices, the network 120, etc. Communication ports may include such things as local area network adapters, wireless communication devices or components, wireless telephone communication ports, etc. In some embodiments, a communications port 552 may allow the terminal 116 to receive radio timing or other information.

The terminal 116 also may include an internal clock element 554 to maintain an accurate time and date for the terminal 116, create time stamps for communications received or sent by the terminal 116, etc. In some embodiments, the processor 550 may be operative to implement one or more steps of the methods disclosed herein.

If desired, the terminal 116 may include one or more output devices 556 such as a printer, infrared or other transmitter, antenna, audio speaker, display screen or monitor, text to speech converter, etc., as well as one or more input devices 558 such as a bar code reader or other optical scanner, infrared or other receiver, antenna, magnetic stripe reader, floppy disk drive, CR-ROM drive, image scanner, roller ball, touch pad, joystick, touch screen, microphone, computer keyboard, miniature keypad, computer mouse, etc. In some embodiments, an input device may allow the terminal 116 to receive radio timing or other information.

In addition to the above, the terminal 116 may include a memory or data storage device 560 to store information, software, databases, communications, device drivers, measurements, etc. The memory or data storage device 560 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The terminal 116 also or alternatively may include separate ROM 562 and RAM 564.

The processor 550 and the data storage device 560 in the terminal 116 each may be, for example: (i) located entirely within a single computer or other computing device; or (ii) connected to each other by a remote communication medium, such as a serial port cable, telephone line or radio frequency transceiver. In some embodiments, the terminal 116 may comprise one or more computers that are connected to a remote terminal computer for maintaining databases.

A conventional personal computer or workstation with sufficient memory and processing capability may be used as the terminal 116. The terminal 116 preferably is capable of high volume transaction processing, performing a significant number of signal processing, mathematical and logical calculations for communications and database searches. A Pentium™ microprocessor, such as the Pentium III™ or IV™ microprocessor manufactured by Intel Corporation, may be used for the processor 550. Other or equivalent processors are available from Motorola, Inc., AMD, or Sun Microsystems, Inc. The processor 550 also may comprise one or more microprocessors, computers, computer systems, etc.

Software may be resident and operating or operational on the terminal 116. The software may be stored on the data storage device 560 and may include a control program 566 for operating the terminal, databases, etc. The control program 566 may control the processor 550. The processor 550 preferably performs instructions of the control program 566, and thereby operates in accordance with the present invention, and particularly in accordance with the methods described in detail herein. The control program 566 may be stored in a compressed, uncompiled and/or encrypted format. The control program 566 furthermore includes program elements that may be necessary, such as an operating system, a database management system and device drivers for allowing the processor 550 to interface with peripheral devices, databases, etc. Appropriate program elements are known to those skilled in the art, and need not be described in detail herein.

According to an embodiment of the present invention, the instructions of the control program may be read into a main memory from another computer-readable medium, such as from the ROM 562 to the RAM 564, or the control program or portions of it may be read in from some other external entity using the communication ports 552 or input device 558. Execution of sequences of the instructions in the control program causes the processor 550 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 550, communication port 552, clock 554, output device 556, input device 558, data storage device 560, ROM 562, and RAM 564 may communicate or be connected directly or indirectly in a variety of ways. For example, the processor 550, communication port 552, clock 554, output device 556, input device 558, data storage device 560, ROM 562, and RAM 564 may be connected via a bus 572.

While specific implementations and hardware/software configurations for the terminal 116 have been illustrated, it should be noted that other implementations and hardware/software configurations are possible and that no specific implementation or hardware configuration is needed. Thus, not all of the components illustrated in FIG. 6 may be needed for a terminal implementing the methods disclosed herein.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed:

1. A method for determining radio timing measurement information, comprising:
making a radio timing measurement for each of a plurality of radio sources 1, . . . , N−1 at respective times T₁, . . . , T_{N-1};
making a radio timing measurement of a common radio source N for each of times T₁₊, . . . , T_{N-1+}; and
determining a radio timing measurement for said common radio source N for each of said times T₁, . . . , T_{N-1} based on said radio timing measurement of said common radio source N for each of said times T₁₊, . . . , T_{N-1+}.

2. The method of claim 1, further comprising:
providing data indicative of said radio timing measurements for said plurality of radio sources 1, . . . , N−1 determined for said respective distinct times T₁, . . . , T_{N-1} and said radio timing measurements for said common radio source N determined for each of said times T₁, . . . , T_{N-1}.

3. The method of claim 1, wherein said making a radio timing measurement for each of a plurality of radio sources 1, . . . , N−1 at respective distinct times T₁, . . . , T_{N-1} includes:
making a radio timing measurement for each of a plurality of radio sources 1, . . . , N−1 at respective distinct times T₁₋, . . . , T_{N-1-}; and
determining a radio timing measurement for each of said plurality of radio sources 1, . . . , N−1 at distinct times T₁, . . . , T_{N-1} based on said radio timing measurement for each of said plurality of radio sources 1, . . . , N−1 at said respective distinct times T₁₋, . . . , T_{N-1-}.

4. The method of claim 3, wherein said time T₁₋ occurs after said time T₁.

5. The method of claim 1, wherein said time T₁ and said time T₂ are less than ten seconds apart.

6. The method of claim 1, wherein said time T₁₊ occurs before said time T₁.

7. The method of claim 1, further comprising:
determining said common radio source.

8. The method of claim 1, further comprising:
determining an observed time difference between said common radio source N and a first of said plurality of radio sources according to said radio timing measurement for said common radio source N at said time T₁ and said radio timing measurement for said first of said plurality of radio sources at said time T₁.

9. The method of claim 8, further comprising:
providing data indicative of said observed time difference.

10. The method of claim 1, further comprising:
determining a real time difference between said common radio source N and a first of said plurality of radio sources associated with said radio timing measurement for said common radio source N at said time T₁.

11. The method of claim 10, further comprising:
providing data indicative of said real time difference.

12. The method of claim 1, wherein each of said plurality of radio sources is at a distinct location.

13. The method of claim 1, wherein said common radio source is a different type of source from at least one of said plurality of radio sources.

14. The method of claim 13, wherein said common radio source is a base station serving a wireless terminal.

15. The method of claim 1, further comprising:
determining a geometric time difference between said common radio source N and a first of said plurality of radio sources associated with said radio timing measurement for said common radio source N at said time T₁.

16. The method of claim 15, further comprising:
providing data indicative of said geometric time difference.

17. The method of claim 15, further comprising:
determining a location of a wireless terminal based, at least in part, on said geometric time difference.

18. The method of claim 17, further comprising:
providing data indicative of said location.

19. The method of claim 17, wherein said wireless terminal conducts said making a radio timing measurement for each of a plurality of radio sources 1, . . . , N−1 at respective times T₁, . . . , T_{N-1}, said making a radio timing measurement of a common radio source N for each of times T₁₊, . . . , T_{N-1+}, and said determining a radio timing measurement for said common radio source N for each of said times T₁, . . . , T_{N-1} based on said radio timing measurement of said common radio source N for each of said times T₁₊, . . . , T_{N-1+}.

20. The method of claim 1, wherein a wireless terminal conducts said making a radio timing measurement for each of a plurality of radio sources 1, . . . , N−1 at respective times T₁, . . . , T_{N-1}, said making a radio timing measurement of a common radio source N for each of times T₁₊, . . . , T_{N-1+}, and said determining a radio timing measurement for said common radio source N for each of said times T₁, . . . , T_{N-1} based on said radio timing measurement of said common radio source N for each of times T₁₊, . . . , T_{N-1+}.

21. The method of claim 1 wherein the times T₁₊, . . . , T_{N-1+} are all distinct.

22. The method of claim 1 wherein some of the times T₁₊, . . . , T_{N-1+} are the same.

23. A method for providing radio timing measurement information, comprising:
making a first measurement of radio timing information for a first radio transmission source at a first instant in time;
making a second measurement of radio timing information for a common radio transmission source at a second instant in time;
determining a third measurement of radio timing information for said common radio transmission source for said first instant in time based on said second measurement;
making a fourth measurement of radio timing information for a second radio transmission source at a third instant in time;
making a fifth measurement of radio timing information for said common radio transmission source at a fourth instant in time;
determining a sixth measurement of radio timing information for said common radio transmission source for said third instant in time based on said fifth measurement; and
providing data indicative of said first measurement, said third measurement, said fourth measurement, and said sixth measurement.

24. A method for providing radio timing measurement information, comprising:
making a first measurement of radio timing information for a first radio transmission source at a first instant in time;
determining a second measurement of radio timing information for said first radio transmission source at a second instant in time based on said first measurement;
making a third measurement of radio timing information for a common radio transmission source at a third instant in time;
determining a fourth measurement of radio timing information for said common radio transmission source for said second instant in time based on said third measurement;
making a fifth measurement of radio timing information for a second radio transmission source at a fourth instant in time;
determining a sixth measurement of radio timing information for said second radio transmission source at a fifth instant in time based on said fifth measurement;
making a seventh measurement of radio timing information for said common radio transmission source at a sixth instant in time;
determining an eighth measurement of radio timing information for said common radio transmission source for said fifth instant in time based on said seventh measurement; and
providing data indicative of said second measurement, said fourth measurement, said sixth measurement, and said eighth measurement.

25. A system for determining radio timing measurement information, comprising:
a memory;
a communication port; and
a processor connected to said memory and said communication port, said processor being operative to:
make a radio timing measurement for each of a plurality of radio sources 1, . . . , N−1 at respective times T₁, . . . , T_{N-1};
make a radio timing measurement of a common radio source N for each of times T₁₊, . . . , T_{N-1+}; and
determine a radio timing measurement for said common radio source N for each of said times T₁, . . . , T_{N-1} based on said timing measurement of said common radio source N for each of said times T₁₊, . . . , T_{N-1+}.

26. The system of claim 25, wherein said processor is further operative to provide data indicative of said radio timing measurements for said plurality of radio sources 1, . . . , N−1 determined for said distinct times T₁, . . . , T_{N-1} and said radio timing measurements for said common radio source N determined for each of said times T₁, . . . , T_{N-1}.

27. A computer program product in a computer readable medium for determining radio timing measurement information, comprising:
first instructions for obtaining a radio timing measurement for each of a plurality of radio sources 1, . . . , N−1 at respective times T₁, . . . , T_{N-1};
second instructions for obtaining a radio timing measurement of a common radio source N for each of times T₁₊, . . . , T_{N-1+}; and
third instructions for obtaining a radio timing measurement for said common radio source N for each of said times T₁, . . . , T_{N-1} based on said radio timing measurement of said common radio source N for each of said times T₁₊, . . . , T_{N-1+}.

28. The computer program product of claim 27, further comprising:
fourth instructions for sending data indicative of said radio timing measurements for said plurality of radio sources 1, . . . , N−1 determined for said respective distinct times T₁, . . . , T_{N-1} and said radio timing measurements for said common radio source N determined for each of said times T₁, . . . , T_{N-1}.
